(19) United States
(12) Patent Application Publication
(10) Pub. No.: US 2003/0087643 A1
(43) Pub. Date: May 8, 2003

(54) Method of providing a cellular service connection for a mobile vehicle

(75) Inventor: William E. Mazzara, Drayton Plains, MI (US)

Correspondence Address: ANTHONY LUKE SIMON, General Motors Corporation, Legal Staff, Mail Code 482-C23-B21, 300 Renaissance Center, P.O. Box 300, Detroit, MI, 48265-3000, US

(73) Assignee: General Motors Corporation

(21) Appl. No.: 10/001,105

(22) Filed: Nov. 2, 2001

(51) Int. Cl. H04Q 7/20

(52) U.S. Cl. 455/450; 455/434

(57) ABSTRACT

The invention provides a method of providing a cellular service connection for a mobile vehicle. A primary band is selected from a predetermined access list. It is determined whether at least one channel is available within the primary band. A secondary band from the predetermined access list is selected if it is determined that there are no available channels within the primary band.

### FIELD OF THE INVENTION

This invention generally relates to a method of providing a cellular service connection for a mobile vehicle. In particular, the invention relates to a method of providing a connection to a cellular network while roaming.

### BACKGROUND OF THE INVENTION

Information and interactive services available to mobile vehicles are increasing due to the demand of mobile vehicle operators for services such as navigation assistance, directory assistance, vehicle maintenance assistance, roadside assistance, information services assistance and emergency assistance. Requests for many of these services occur when a vehicle is outside of a home region, for example, during personal travel or business trips to neighboring or distant cities. In addition, the number of vehicles outfitted with suitable equipment to request and receive service information is growing.

Transmission of data and voice information to and from a mobile vehicle requires at least a portion of the communication system to be a wireless link. This link may be shared with many other mobile vehicles as well as many mobile phone users not in mobile vehicles. With the proliferation of mobile phones for personal use and for mobile vehicle assistance, a preferred cellular service carrier may be unable to meet the needs of all the clients and subscribers. Requests for mobile phone connections may be detrimentally impacted due to the unavailability of transmission channels during times of high usage, or limited service access in certain markets. Call requests may be deferred to non-preferred carriers, or may be denied altogether. Consequently, there may be times when service with a preferred carrier is not available, or service may not be available at all.

Service requests from mobile vehicles may occur often while roaming outside of local calling areas. Mobile phones located outside the home service area may not receive adequate priority for access when outside the home service area. One or more wireless carriers may be capable of providing wireless connections to the mobile vehicle while roaming, however, the carriers may not have a contract for providing service to the mobile vehicle in that geographical area. If there are no contract wireless service providers in an area, then a wireless connection may be unobtainable or require a premium payment.

Mobile vehicles may reside in and cross multiple market areas, with access requests possible in each market area. As a vehicle traverses through one cellular region to another, multiple carriers may be utilized. Provisions for continued services to roamers may require an allocation of voice channels that a carrier may prefer to reserve for subscribers in the home region. As a result, a mobile vehicle may not get a connection with a secondary carrier due to unavailability of channels.

In cases where a cellular phone user is unable to obtain a wireless connection with a primary contract carrier, the user may be given a message that no service is available and left to his/her own means to procure services with another carrier. A mobile vehicle would benefit from having a means for automatically locating services with a secondary carrier within the same band and using the same acquisition technology as the primary carrier. The secondary carrier could be, for example, in an analog cellular band such as 800 MHZ cellular rather than a PCS band nominally at 1900 MHz. The secondary carrier also may be employing a different technology such as TDMA, for example, rather than CDMA or vice versa. When the secondary carrier is not within the same band, it would be desirable to methodically switch and search for a secondary carrier outside of the primary band. When outside of the home market region, it also would be desirable to employ a secondary carrier that is a preferred contract carrier and avoid unnecessary premium charges. It would also be desirable to automatically determine a preferred primary or secondary contract carrier based on the geographical region where the mobile vehicle is currently located. Cell phone functions such as registration and call origination may then be done with a preferred contract carrier.

In situations where a mobile vehicle urgently requires a cellular phone connection, a fallback position may be desirable. A fallback position might include the use of a selected phone number that receives high priority service by multiple carriers. Another fallback position might include the use of the well-established mobile phone system such as the analog mobile phone system in conjunction with a widely recognized phone number for high priority service.

It is the object of this invention, therefore, to provide a method for establishing a cellular service connection for a mobile vehicle to a cellular network, using preferred carriers and procedures depending on the geographical region in which the mobile vehicle is located, and overcome the deficiencies and obstacles described above.

### SUMMARY OF THE INVENTION

One aspect of the invention provides a method of providing a cellular service connection for a mobile vehicle. A primary band may be selected from a predetermined access list. It may be determined whether at least one available channel is in the primary band and if there are no available channels, a channel in a secondary band may be selected from the access list.

The primary band may contain a prescribed set of digital cellular channels. A cellular phone may be registered on an available channel in the primary band. A call request may be originated on the cellular phone, and an available channel may be accessed from the predetermined access list in response to the origination of the call request. The predetermined access list may contain one or more instructions to reach a preferred cellular service.

System compatibility may be determined on an available channel within the primary band. If no compatibility is determined, then a secondary band may be selected from the predetermined access list. The available channel may be compared to a priority list of preferred system carriers. A system identifier may be received, and compared with a plurality of preferred system identifiers in the predetermined access list to determine system compatibility. An analog channel may be accessed if no system on the predetermined access list is compatible. An analog channel may be accessed using a cleared call connection number that originates a call request.

Another aspect of the current invention is a computer usable medium, including a program for providing a cellular service connection for a mobile vehicle.

The program may include computer program code for selecting a primary band from a predetermined access list, determining whether at least one available channel is within the primary band, and selecting a secondary band from the predetermined access list, if it is determined that there are no available channels within the primary band.

The program may include computer program code for registering a cellular phone on an available channel in the primary band. The program may include computer program code for originating a call request on the cellular phone, and accessing an available channel from the predetermined access list in response to the call origination request.

The computer usable medium may further contain a program including computer program code for determining system compatibility if an available channel is within the primary band, and computer program code for selecting the secondary band from the predetermined access list based on the compatibility determination. The computer program code may access an analog channel if no system is compatible based on the predetermined access list.

Another aspect of the current invention is a cellular connection system for providing a cellular service connection for a mobile vehicle.

The cellular connection system may provide a means for selecting a primary band from a predetermined access list, a means for determining whether at least one available channel is within the primary band, and a means for selecting a secondary band from the predetermined access list, if it determined that there are no available channels within the primary band.

The system may provide a means for registering a cellular phone on an available channel in the primary band. The system may provide a means for originating a call request on a cellular phone, and a means for accessing an available channel from the predetermined access list in response to the origination of the call request.

The cellular connection system may also provide a means for determining system compatibility if an available channel is within the primary band, and a means for selecting the secondary band from the predetermined access list based on the compatibility determination. The system may further include a means for accessing an analog channel if no system is compatible based on the predetermined access list.

The aforementioned, and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic diagram of one embodiment of a cellular connection system for providing a cellular service connection for a mobile vehicle, in accordance with the current invention;

FIG. 2 is a flow diagram of one embodiment of a method of providing a cellular service connection for a mobile vehicle, in accordance with the current invention; and

FIG. 3 is a flow diagram of another embodiment of a method of providing a cellular service connection for a mobile vehicle, in accordance with the current invention.

### DETAILED DESCRIPTION OF THE PRESENTLY PREFERRED EMBODIMENTS

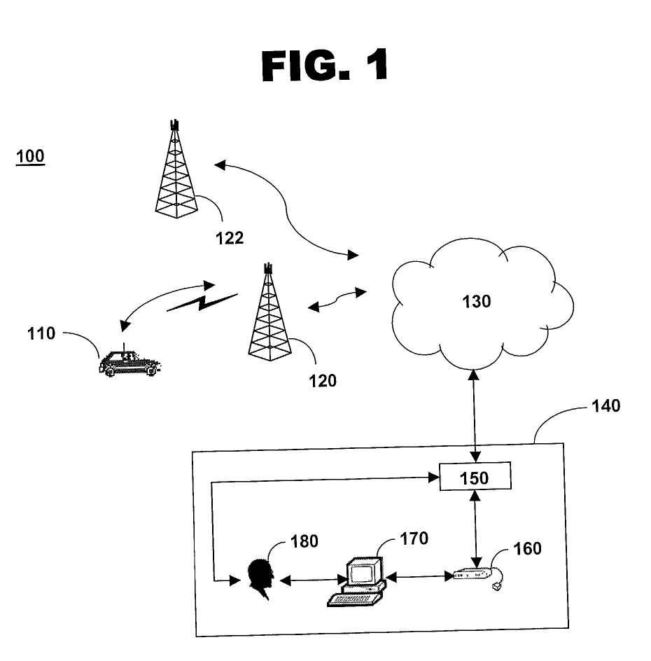

FIG. 1 shows one embodiment of a system for providing a cellular service connection to a mobile vehicle, in accordance with the present invention at 100.

Cellular connection system 100 may include one or more mobile vehicle clients 110; one or more carrier systems 120, 122; one or more communication networks 130; and one or more communication nodes 140. A communication node may contain one or more data and voice switches 150; one or more communication node modems 160; one or more service applications 170; and one or more service advisors 180.

Mobile vehicle client 110 may be a mobile vehicle equipped with suitable hardware and software for transmitting and receiving voice and data communications. Mobile vehicle client 110 may contain a cellular or mobile phone for sending or receiving voice or data communications. The cellular phone may be, for example, an analog phone or a digital phone. An analog phone may operate, for example, on an analog cellular band. A digital phone may operate, for example, on a PCS (personal communication services) or digital cellular band. The cellular phone may be a dual band phone or a dual mode phone. A dual band phone may operate on more than one band, for example, on a band of frequencies nominally at 800 MHz or on a band of frequencies nominally at 1900 MHz. A dual mode phone may also operate as an analog phone as well as a digital phone. The cellular phone may be a combination dual-mode and dual-band phone. The cellular phone may reside in a hardware cluster located in the mobile vehicle.

Mobile vehicle client 110 may also be an occupant or driver of a mobile vehicle who carries suitable hardware and software for transmitting and receiving voice and data communications. Mobile vehicle client 110 sends radio transmissions to and receives radio transmissions from carrier system 120, 122.

Carrier system 120, 122 is a wireless communications carrier. Carrier system 120, 122 may be, for example, a mobile telephone system. The mobile telephone system may be an analog mobile telephone system operating over a prescribed band nominally at 800 MHz. The mobile telephone system may be a digital mobile telephone system operating over a prescribed band nominally at 800 MHz, 1900 MHz, or any suitable band capable of carrying mobile communications. Carrier systems 120, 122 may transmit to and receive signals from mobile vehicle client 110. Mobile vehicle client 110 may transmit to and receive signals from carrier system 120 or carrier system 122. Carrier systems 120, 122 may be connected to a communication network 130.

Communication network 130 may comprise a mobile telephone switching office, a public switched telephone network, another wireless network, a fiber network, a wired network, an optical network, or any combination thereof. Communication network 130 connects carrier system 120, 122 to a communication node 140.

Communication node 140 may contain a data and voice switch 150. Switch 150 may be connected to communication network 130. Switch 150 may transmit voice or data transmissions from communication node 140. Switch 150 may also receive voice or data transmissions from mobile vehicle 110 through Carrier system 120, 122 and communication network 130. Switch 150 may receive data transmissions from or send data transmissions to communication node modem 160, or receive voice transmissions from or send voice transmissions to service advisor 180.

Communication node 140 may contain one or more communication node modems 160. Communication node modem 160 may send data to or receive data from switch 150. Modem 160 may transfer data to or from service application 170.

Communication node 140 may contain one or more service applications 170. Service application 170 may be any suitable hardware and software capable of providing requested services from mobile vehicle client 110. Service application 170 may provide one or more of a variety of services, including navigation assistance, directory assistance, emergency assistance, roadside assistance, business or residential assistance, information services assistance, and emergency assistance. Service application 170 may communicate with mobile vehicle client 110 through carrier system 120, 122, communication network 130, and communication node switch 150 using data transmissions through communication node modem 160. Service application 170 may provide requested information to service advisor 180.

Service advisor 180 may be a real advisor or a virtual advisor. A real advisor may be a human being in verbal communication with mobile vehicle client 110. A virtual advisor may be a synthesized voice interface responding to requests from mobile vehicle client 110. Service advisor 180 may provide services to mobile vehicle client 110. Services provided by service advisor 180 may include navigation assistance, directory assistance, roadside assistance, business or residential assistance, information services assistance, and emergency assistance. Service advisor 180 may communicate with mobile vehicle client 110 through carrier system 120, 122 and communication network 130 using voice transmissions, or through service application 170 and communication node modem 160 using data transmissions. Switch 150 may select between voice transmissions and data transmissions. Connection between mobile vehicle client 110 and, for example, a communication node, using communication network 130 and carrier system 120, 122, may occur through steps including registration and call origination with carrier system 120, 122. A preferred carrier may be selected using system identification information broadcasted by one carrier to aid in the selection of a preferred carrier in the same geographical region as the mobile vehicle.

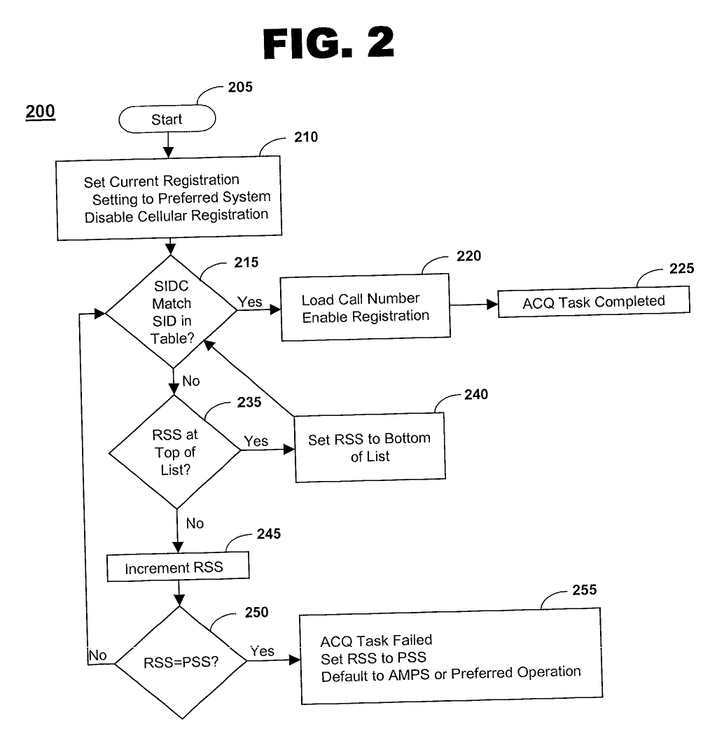

FIG. 2 shows a flow diagram of one embodiment of a method of providing a cellular service connection for a mobile vehicle, in accordance with the present invention at 200.

As seen at block 205, an acquisition task may be started. At the start of the acquisition task, steps to acquire a preferred wireless carrier on a digital cellular band or an analog cellular band may be initiated. The digital cellular band may be, for example, a set of prescribed frequencies nominally at 800 MHz or a set of prescribed frequencies nominally at 1900 MHz. An analog cellular band may be, for example, a set of prescribed frequencies nominally at 800 MHz. The preferred acquisition type may be, for example, code division multiple access, time division multiple access or frequency division multiple access.

The acquisition task may be initiated upon power up of a cellular or mobile phone, at the termination of a call, upon change of a system identifier, or at the expiration of an operation timer if the system is operating on an analog cellular network. Power up may occur, for example, when mobile vehicle client 110 desires to initiate a call request, or when the vehicle containing mobile client 110 is turned on. The termination of a call may occur, for example, when mobile vehicle client 110 no longer wishes to maintain a connection, or when data and voice communication sessions with mobile vehicle client 110 have ended. The system identifier may change, for example, when mobile vehicle client 110 roams from one cellular market to another, or when conditions such as environmental conditions prevail that interrupt service with the currently connected carrier. An internal timer on a mobile phone, for example, may expire if service from a certain carrier type, such as an analog carrier, is not received within a preset time.

The primary band may be selected from a predetermined access list. The predetermined access list may contain a list of specific instructions to reach channels over which a cellular service operates. The predetermined access list may include channels such as A-side cellular, 354 cellular, or C-band PCS. The predetermined access list may contain instructions to reach one or more preferred cellular services. The predetermined access list may be stored in the mobile phone or reside within mobile vehicle client 110.

As seen at block 210, the current registration setting may be set to a preferred system setting in the predetermined access list. The registration system setting may be a set of allocated frequencies to which the mobile phone is currently tuned. The allocated frequencies may correspond with control channels associated with the cellular band. The preferred system setting may be a preferred set of frequencies associated with control channels. The preferred system setting may be a set of control frequencies in an analog cellular band or a set of control frequencies in a digital cellular band. A mobile phone may contain one or more preferred system settings, corresponding to one or more cellular bands. The preferred system setting may be based on the geographical region of the home system for the mobile vehicle. The preferred system setting and the registration system setting may contain more than one accessible channel. As seen at block 210, registration may be disabled. Registration may include establishing the identity of the mobile phone with a wireless carrier in a cell region. Disabling registration may involve a temporary postponement of the registration sequence.

A current system identifier of a wireless carrier may be determined using an available channel in the primary band. If a carrier is not available, another channel within the primary band may be used. A carrier or system may be compatible if a channel is available within the primary band. A carrier may be preferred if the system identifier is contained in a system identifier table. A carrier on an available channel may be determined as preferred by comparing the channel to a list of preferred carriers. If no carrier is compatible on an available channel within the primary band, a second band may be selected. The second band may be selected from the predetermined access list based on the compatibility determination. A preferred carrier may be searched for in the second band. The search for a preferred carrier in the second band may proceed in a manner similar to the search for a preferred carrier in the primary band. If no channels are available within the primary band, a secondary band may be used.

As seen at block 215, if the current system identifier (SIDC) is the same as the home system identifier, or if the current system identifier is the same as any system identifier in a system identifier table, the mobile phone may be connected to the wireless network as seen at block 220. The system identifier table may contain one or more preferred system identifiers. A system identifier may be preferred based on the geographical region in which the mobile vehicle is located. The set of preferred system identifiers may be based on the current system identifier. A system identifier may be a code ascribed to a specific carrier. A system identifier may be a code identified with a specific cellular market. A system identifier may be a code associated with a home carrier, for example, a wireless carrier with whom a mobile phone is subscribed. A system identifier may be a prescribed number broadcasted from a cellular base station in a specific cellular market. A system identifier may be a prescribed number located in a cell phone. The current system identifier is the system identifier of the wireless carrier to which the mobile phone is subscribed. The current system identifier may be a system identifier associated with the cellular market where the mobile phone is currently located. The system identifier table may reside within the mobile phone. The system identifier table may reside within mobile vehicle client 110. If a channel is available in the primary band, then a system or carrier corresponding to the channel may be compatible if, for example, the system identifier is contained in a priority list of preferred carriers. A registration or a call origination may then occur. If a channel is available in the primary band, a channel identifier may be received and compatibility determined. If a preferred carrier is not found on an available channel in the primary band, a second band may be searched in a similar manner.

As seen at block 220, if the system identifier broadcasted by a wireless carrier in the vicinity of the mobile phone matches the home system identifier of the mobile phone, or matches a system identifier located in a system identifier table located in the mobile phone, the mobile phone may be connected to the network, a call connection number may be loaded, and cellular phone registration may be enabled. The mobile phone may be connected to the network when data or voice transmissions may occur between the mobile phone and the wireless carrier. The call connection number may be a phone number of a person, business or point of interest. The call connection number may be a number associated with a call center. A call center may be a communication node where services from mobile vehicle client 110 may be requested. When call registration is enabled, registration of the mobile phone with the wireless carrier may occur. The mobile phone may be registered on an available channel in the primary band.

As seen at block 225, the acquisition task may be completed and mobile phone registration may be completed. The call may be connected, and data and voice transmissions with the mobile phone may occur. A call request may be originated from the cellular phone, using the primary band from the predetermined access list. If there are no available channels in the primary band, a call request may be originated on an available channel in a second band.

As seen at block 215, in cases where the current system identifier does not match the home system identifier or any system identifier in the system identifier table, a check may be made whether a registration system setting (RSS) is at the top of the predetermined access list as seen at block 235. The registration system setting may be at any one of a set of frequencies corresponding to control channels of the wireless carrier over which registration information may be transmitted. If the registration system setting is at the top of the predetermined access list, the registration system setting may be set to the registration system setting at the bottom of the predetermined access list, as seen at block 240. A check may then be made on whether the current system identifier matches the home system identifier or any system identifier listed in the system identifier table as seen at block 215. If the current system identifier matches the home system identifier listed in the system identifier table, or if the current system identifier matches any system identifier in the system identifier table, then registration may occur and a call may be placed. If the current system identifier does not match the home system identifier or any system identifier in the system identifier table, and if the registration system setting is not at the top of the current band, the registration system setting may be incremented as seen at block 245. Alternatively, the registration system setting may be set to the next entry on the predetermined access list.

As seen at block 250, a check may be made to determine if the registration system setting is the same as the preferred system setting (PSS). If the response to the check is negative, then a check may be made for a system identifier match as seen at block 215, using the incremented registration system setting. As seen at block 250, in cases where the registration system setting is the same as the preferred system setting, the acquisition task may have failed as seen at block 255. The registration system setting may then be set to the preferred system setting. Access may then be requested on the analog cellular band. Alternatively, access may be requested on a preferred operation using any cellular technology with broad geographical or national coverage. Access may be requested using a cleared call connection number on an analog channel or with a broadly based cellular technology. The cleared call connection number may be suitable for data and voice transmissions. The cleared call number may include, for example, only voice transmissions. A cleared call connection number on an analog channel may be used, for example, if it is determined that the received system identifiers do not match any identifier in the predetermined access list. An analog channel may be accessed, for example, if no system is compatible based on the predetermined access list. A call request may be originated, for example, on an analog channel using a cleared call connection number.

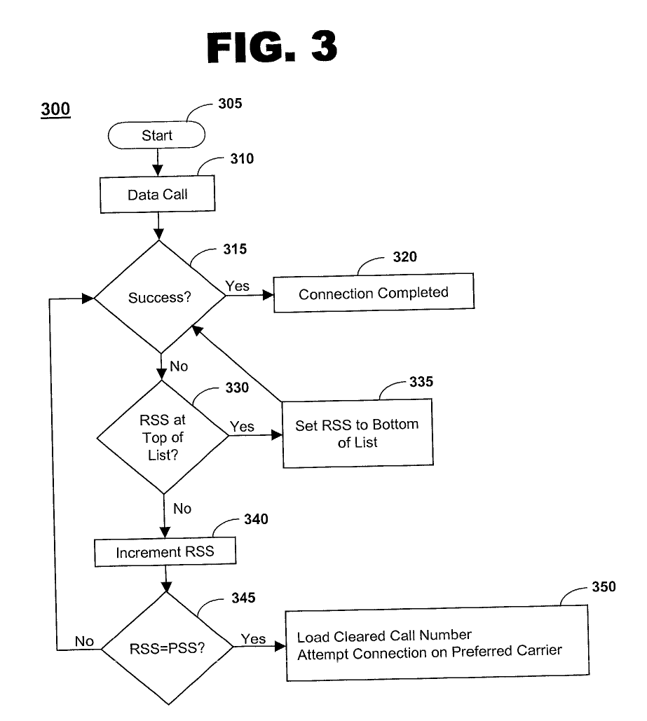

FIG. 3 shows a flow diagram of another embodiment of a method of providing a cellular service connection for a mobile vehicle in accordance with the present invention at 300.

As seen at block 305, an acquisition task may be started. The acquisition task may be initiated upon power up of a cellular or mobile phone, at the termination of a call, upon change of a system identifier, or at the expiration of an operation timer if the system is operating on, for example, an analog network. During the start of the acquisition task, steps to acquire a preferred wireless carrier on a digital or analog cellular band may be initiated.

As seen at block 310, a data call may be attempted. If the data call is successfully connected as seen at block 315, then the acquisition task may be completed as seen at block 320 and registration may occur. The call may be connected, and data and voice transmissions with the mobile phone may occur.

As seen at block 315, if a data call connection attempt is unsuccessful, a check may be made to determine if the registration system setting is at the top of the predetermined access list as seen at block 330. If the registration system setting is at the top of the predetermined access list, then the registration system setting may be set to the bottom of the predetermined access list as seen at block 335. A check may then be made to determine whether a data call connection has been successful, as seen at block 315.

As seen at block 330, if the registration system setting is not at the top of the predetermined access list, then the registration system setting may be incremented as seen at block 340. The registration system setting may now be set, for example, to system A in the analog cellular band, if it was previously set to system B in the analog cellular band. The registration system setting may now be set for example, to system E in a digital cellular or PCS band, if it was previously set to system D in a PCS band. The registration system setting may be advanced through all PCS or digital cellular systems in any desired or prescribed order.

As seen at block 345, if the registration system setting is not the same as the preferred system setting, another data call may be attempted and checked for success as seen at block 315. As seen at block 345, if the registration system setting is the same as the preferred system setting, a call connection on an analog band may be attempted with a preferred analog cellular carrier by using a cleared call connection number, as seen at block 350. Alternatively, the call connection may be attempted with any broadly based cellular phone system. A cleared call connection number may be a phone number recognized by one or more carriers as a phone number that does not require authentication of mobile client 110 in order to be connected. The acquisition task may be completed, the call may be connected, and data and voice transmissions with the mobile phone may occur using the cleared number.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method of providing a cellular service connection for a mobile vehicle comprising:
selecting a primary band from a predetermined access list;
determining whether at least one channel is available within the primary band; and
selecting a secondary band from the predetermined access list, if it is determined that there are no available channels within the primary band.

2. The method of claim 1 wherein the primary band comprises a prescribed set of digital cellular channels.

3. The method of claim 1 further comprising:
registering a cellular phone on an available channel in the primary band.

4. The method of claim 1 further comprising:
originating a call request on a cellular phone; and
accessing an available channel from the predetermined access list in response to the origination of the call request.

5. The method of claim 1 wherein the predetermined access list comprises at least one instruction to reach a preferred cellular service.

6. The method of claim 1 further comprising:
determining system compatibility if an available channel is within the primary band; and
selecting the secondary band from the predetermined access list based on the compatibility determination.

7. The method of claim 6 wherein the available channel is compared to a priority list of preferred system carriers.

8. The method of claim 6 wherein the compatibility determination comprises receiving a system identifier and comparing the system identifier to a plurality of preferred system identifiers in a system identifier table.

9. The method of claim 6 further comprising:
accessing an analog channel if no system is compatible based on the predetermined access list.

10. The method of claim 9 wherein accessing the analog channel comprises originating a call request using a cleared call connection number.

11. A computer usable medium including a program for providing a cellular service connection for a mobile vehicle, comprising:
computer program code for selecting a primary band from a predetermined access list;
computer program code for determining whether at least one channel is available within the primary band; and
computer program code for selecting a secondary band from the predetermined access list, if it is determined that there are no available channels within the primary band.

12. The computer usable medium of claim 11, further comprising:
computer program code for registering a cellular phone on an available channel in the primary band.

13. The computer usable medium of claim 11, further comprising:
computer program code for originating a call request on a cellular phone; and
computer program code for accessing an available channel from the predetermined access list in response to the origination of the call request.

14. The computer usable medium of claim 11 further comprising:
computer program code for determining system compatibility if an available channel is within the primary band; and
computer program code for selecting the secondary band from the predetermined access list based on the compatibility determination.

15. The computer usable medium of claim 14 further comprising:
computer program code for accessing an analog channel if no system is compatible based on the predetermined access list.

16. A cellular connection system for providing a cellular service connection for a mobile vehicle comprising:
means for selecting a primary band from a predetermined access list;
means for determining whether at least one channel is available within the primary band; and
means for selecting a secondary band from the predetermined access list, if it is determined that there are no available channels within the primary band.

17. The system of claim 16 further comprising:
means for registering a cellular phone on an available channel in the primary band.

18. The system of claim 16 further comprising:
means for originating a call request on a cellular phone; and
means for accessing an available channel from the predetermined access list in response to the origination of the call request.

19. The system of claim 16 further comprising:
means for determining system compatibility if an available channel is within the primary band; and
means for selecting the secondary band from the predetermined access list based on the compatibility determination.

20. The system of claim 19 further comprising:
means for accessing an analog channel if no system is compatible based on the predetermined access list.
